(19) United States
(12) Patent Application Publication
(10) Pub. No.: US 2014/0247216 A1
(43) Pub. Date: Sep. 4, 2014

(54) TRIGGER AND CONTROL METHOD AND SYSTEM OF HUMAN-COMPUTER INTERACTION OPERATION COMMAND AND LASER EMISSION DEVICE

(71) Applicant: Jin Fang, Shenzhen City (CN)

(72) Inventor: Jin Fang, Shenzhen City (CN)

(73) Assignee: Tencent Technology (Shenzhen) Company Limited, Shenzhen City, Guangdong (CN)

(21) Appl. No.: 14/350,622

(22) PCT Filed: Nov. 14, 2012
(86) PCT No.: PCT/CN2012/081405

§ 371 Date: Apr. 9, 2014

(30) Foreign Application Priority Data
Nov. 8, 2011 (CN) 201110349911.1

(51) Int. Cl. G06F 3/03

(52) U.S. Cl. CPC G06F 3/0325
USPC 345/158

(57) ABSTRACT

Disclosed are a trigger and control method and system of a human-computer interaction operation command and an associated laser emission device, the method comprising: utilizing a camera device to shoot a display area outputted by an image output device; determining the coordinate mapping transformation relationship between the shot display area and the original image output by the image output device; detecting a laser point in the shot display area, and transforming the coordinates thereof into the coordinates in the original image according to the relationship; when the laser point is identified to transmit the code signal corresponding to a certain human-computer interaction operation command, triggering the human-computer interaction operation command corresponding to the code signal at the coordinates in the original image correspondingly transformed from the coordinate of the laser point. The present invention facilitates a user in conducting medium range and long range human-computer interaction operations.

### CROSS-REFERENCE TO RELATED APPLICATIONS

The present application is a 35 U.S.C 371 U.S. National stage application of International Application No. PCT/CN2012/081405, filed on Sep. 14, 2012, which claims the benefit of the Chinese Patent Application No. CN201110349911.1, filed on Nov. 8, 2011, all of which are hereby incorporated by reference in its entirety.

### FIELD OF INVENTION

The present invention relates to human-computer interaction system technologies, and in particular, to a trigger and control method and system of human-computer interaction operation command and an associated laser emission device.

### BACKGROUND

Human-Computer Interaction Techniques refer to those that effectively achieve interaction between human and data processing equipment by means of input and output devices of the equipment. The examples thereof comprise that machines provide a large amount of relevant information and prompt requests and so on to humans by means of output or display devices, and that humans input relevant information and operation commands and so on into machines by means of input devices.

In the traditional interaction process using a computer such as a desktop or a laptop, an operation command is triggered by an input device such as a keyboard or a mouse. In a presentation scene where a computer and a projector are used in conjunction, the speaker usually stands at some distance from the computer, and when he needs to operate on the computer, he usually has to approach the computer to conduct a corresponding mouse or keyboard operation. In this circumstance, the medium- or long-range human-computer interaction is impossible to achieve, making it inconvenient for users to conduct human-computer operations. In a further-developed solution, a technique of wireless page-turning pen is developed, and a user can use a wireless page-turning pen for simple page-turning operations. However, this wireless page-turning pen is unable to achieve relatively complicated operations such as mouse cursor movements and clicks, and is still inconvenient for users to use.

### SUMMARY OF THE INVENTION

In view of the above problems, one aspect of the present invention provides a trigger and control method and system of human-computer interaction operation command to facilitate conducting medium range and long range human-computer interaction operations for users.

Another aspect of the present invention further provides a laser emission device associated with the trigger and control system of human-computer interaction operation command, the device being able to precisely transmit a laser-coding signal corresponding to the operation command, thus improving the operation precision in medium range and long range human-computer interaction operations.

A trigger and control method of human-computer interaction operation command comprises:

shooting a display area output from an image output device by using a camera device;

determining a coordinate mapping transformation relationship between the display area shot by the camera device and an original image output from the image output device;

detecting a laser point in the display area shot by the camera device, determining the coordinates of the detected laser point, and transforming the coordinates of the detected laser point into the coordinates in the original image output from the image output device according to the coordinate mapping transformation relationship between the display area shot by the camera device and the original image output from the image output device; and

identifying a coding signal delivered from the laser point, wherein when the coding signal delivered from the laser point is identified as corresponding to a human-computer interaction operation command, the human-computer interaction operation command corresponding to the coding signal is triggered at the coordinates in the original image correspondingly transformed from the coordinates of the laser point.

A trigger and control system of human-computer interaction operation command comprises:

an image output module, which is configured to provide an original image to an image output device for outputting the original image;

a camera image acquisition module, which is configured to acquire a display area shot by a camera device, wherein the display area is output from the image output device;

a mapping relationship module, which is configured to determine a coordinate mapping transformation relationship between the display area shot by the camera device and the original image output from the image output device;

a laser point detection module, which is configured to detect a laser point in the display area shot by the camera device;

a positioning module, which is configured to determine the coordinates of the detected laser point, and to transform the coordinates of the detected laser point into the coordinates in the original image output from the image output device according to the coordinate mapping transformation relationship between the display area shot by the camera device and the original image output from the image output device; and

a code identification module, which is configured to identify a coding signal delivered from the laser point, wherein when the coding signal delivered from the laser point is identified as corresponding to a human-computer interaction operation command, the human-computer interaction operation command corresponding to the coding signal is triggered at the coordinates in the original image correspondingly transformed from the coordinates of the laser point.

A laser emission device associated with the above-mentioned trigger and control system of human-computer interaction operation command comprises:

a trigger key of human-computer interaction operation command, which is configured to trigger a corresponding human-computer interaction operation command;

a signal coding unit, which is configured to store laser coding modes corresponding to human-computer interaction operation commands;

a laser transmitter, which is configured to emit a laser beam; and

a laser emission controller, which is configured to read from the signal coding unit the laser coding mode corresponding to the human-computer interaction operation command triggered by the trigger key of human-computer interaction operation command, and to control the laser transmitter to emit the laser beam representing the corresponding laser-coding signal.

Compared with the prior art, all the aspects of the present invention are able to, based on the cooperation of a laser device and a camera device, accomplish positioning a laser signal and triggering the corresponding operation command at the position of the laser signal, by detecting and identifying the laser signal that a user issues to a display area at a medium or long range of distance. The laser signal can encode and simulate a plurality of operation commands, so as to facilitate conducting human-computer interaction operations in a medium or long range scene for users. The laser emission device according to the present invention can also precisely emit the laser-coding signal corresponding to an operation command, improving the operation precision in medium and long range human-computer interaction operations.

The above description is only a summary of the technical solutions of the present invention. In order to make the technical means of the present invention clearer and thus implementable according to the contents disclosed in the specification, as well as to enable the above-mentioned and other features and advantages of the present invention to be readily understood, embodiments will be provided with a detailed description in the following by reference to the accompanying drawings.

### BRIEF DESCRIPTION OF THE DRAWINGS

FIG. 1 is a schematic diagram of connecting some devices in a system in an application scene of the method according to the present invention;

FIG. 2 is a schematic diagram of image calibration of a projection area shot by a camera head;

FIG. 3 is a schematic diagram of a calibration image acquired by a camera head;

FIG. 4 is a schematic diagram of the process of detecting a laser point in an image shot by a camera head;

FIG. 5 is a schematic diagram of a flicking code of laser beam;

FIG. 6 is a schematic diagram of a trigger and control system of human-computer interaction operation command according to the present invention;

FIG. 7a is a schematic diagram of a specific constitution of the mapping relationship module in the trigger and control system;

FIG. 7b is a schematic diagram of a specific constitution of the laser point detection module in the trigger and control system;

FIG. 7c is a schematic diagram of a specific constitution of the code identification module in the trigger and control system;

FIG. 8 is a schematic diagram of a laser emission device according to the present invention.

### DETAILED DESCRIPTION

The aforementioned and other technical contents, features and effects of the present invention will be clearly presented in the following detailed description of the preferable embodiments by reference to the appended drawings. However, the appended drawings are only used for reference and explanation, but not meant for imposing any restriction on the present invention.

In an embodiment of the present invention:

a camera device is used to shoot a display area output from an image output device;

a coordinate mapping transformation relationship between the display area shot by the camera device and the original image output from the image output device is determined, wherein the coordinate mapping transformation relationship is expressed by two parts of data: one part is the coordinates of the calibration reference points in the shot image, and the other part is the length ratio and the width ratio of the original image to the shot image;

a laser point is detected in the display area shot by the camera device; the coordinates of the detected laser point are determined, and according to the coordinate mapping transformation relationship between the display area shot by the camera device and the original image output from the image output device, the determined coordinates of the detected laser point are transformed into the coordinates in the original image output from the image output device;

the coding signal delivered from the laser point is identified, wherein when the coding signal delivered from the laser point is identified as corresponding to a certain human-computer interaction operation command, the human-computer interaction operation command corresponding to the coding signal is triggered at the coordinates in the original image correspondingly transformed from the coordinates of the laser point.

The image output device according to the present invention may be a projector, and the corresponding display area output will be a projection area projected by the projector on a screen or a wall or the like; the image output device may also be a display, so the corresponding display area output may be the display screen of the display.

The coding signals by laser according to the present invention can simulate and encode a plurality of operation commands. In the following embodiments of the present invention, a description will be given by illustrating the simulation of mouse operations by a laser. Besides simulating mouse operations, the present invention also applies to simulating more human-computer operation modes, such as simulating a single touch operation, using more than one laser emission device to simulate a multi-touch operation, etc., thus achieving long range human-computer interaction operations.

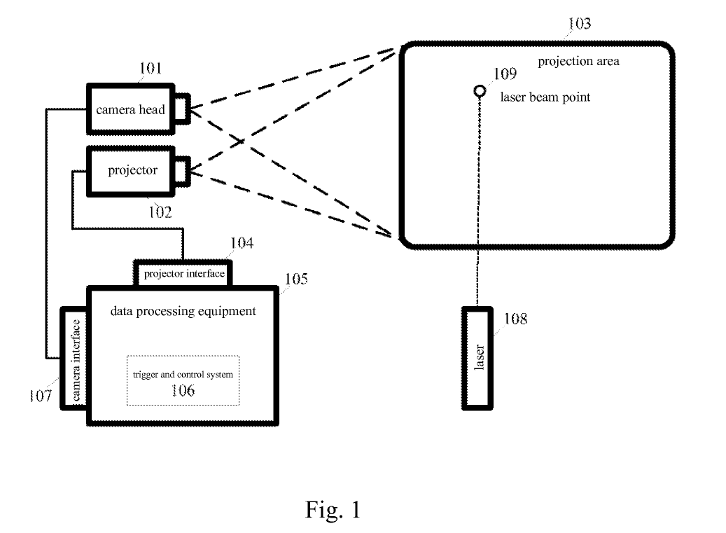

FIG. 1 is a schematic diagram of connecting some devices in a system in an application scene of the method according to the present invention. FIG. 1 illustrates an example of a relatively typical form of connecting devices for implementing the present invention. But the present invention is not limited to this connection scene, and there can be other modes of connection; for instance, the projector may not be an essential device, and may be replaced by a display, and thus the laser may be used to operate directly on the display screen of the display.

By reference to FIG. 1, data processing equipment 105 is connected to a camera head 101 via a camera interface 107. The connection mode may be one of the various connecting solutions well-known in the industry, such as the universal serial bus (USB) connection or the WiFi wireless connection, etc. In another embodiment, the camera head 101 may not be a separate device, but instead, a built-in camera head in the data processing equipment 105. A projector 102 is connected to the data processing equipment 105 via a projector interface 104. The connection mode thereof may be the VGA mode, the composite video output mode, the High Definition Multimedia Interface (HDMI) mode, and other wired or wireless connection modes that can provide video transmission capability.

The projector 102 will project a projection area 103 (that is, the display area according to the present invention), which can be entirely acquired and clearly kept in focus by the camera head 101 by either manual setup or automatic adjustment. In case where the projector is replaced by a display, it is the display area of the display (corresponding to the projection area 103) that can be entirely acquired and clearly kept in focus by the camera head 101 by either manual setup or automatic adjustment. A laser beam emitted by a laser 108 is cast on the projection area 103 to form a laser beam point 109. After the projection area 103 is entirely acquired and clearly kept in focus by the camera head 101, a trigger and control system 106 in the data processing equipment 105 can be enabled. Preferably, the laser beam emitted by the laser 108 can be an infrared laser, and in this case, an infrared filter can be added to the camera head 101, so that the camera head 101 can capture the infrared laser point.

The data processing equipment 105 may be a computing system, of which the program running environment is provided by a CPU, a memory and an operating system. The typical examples thereof include desktop computers, laptop computers, tablet computers, televisions, hand-held equipment possessing computing ability, such as smart phones, and robot equipment possessing computing ability, etc.

The trigger and control system 106 running on the data processing equipment 105 is a software system, and is used to acquire a video image of the projector area 103 by the camera head 101, analyze and calculate the video image, detect the position of the laser beam point 109 emitted by the laser 108 in the image projected by the data processing equipment 105 by the projector 102, transform it into the position of a mouse cursor, and resolve the code information of the varying laser beam of the laser 108 into the simulated mouse operations of single click, double click, or right-button clicking, and pressing, releasing and dragging, all of which are represented by the code information.

A specific explanation of the present invention will be given in the following by describing how the trigger and control system 106 simulates mouse operations by detecting the laser beam point.

Step s01 comprises providing an original image via the projector interface 104 for a projector (that is, the image output device according to the present invention) to output; and meanwhile, acquiring via the camera interface 107 the display area (namely the projection area 103) shot by the camera head, wherein the display area is projected by the projector.

Step s02 comprises determining a coordinate mapping transformation relationship between the projection area 103 shot by the camera head and the original image projected by the projector.

The coordinate mapping transformation relationship is expressed by two parts of data: one part is the calibration data of the projection area, that is, the coordinates of the calibration reference points in the shot image, and the other part is the length ratio and the width ratio of the original image to the shot image.

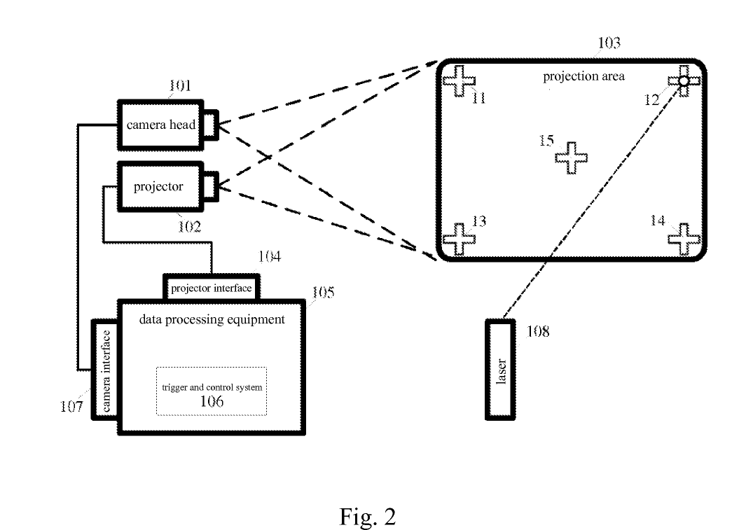

First of all, in order to acquire precisely the coordinate position relationship between the image shot by the camera head and the content projected by the projector, so as to correctly detect and calculate the position of the laser beam point and further to simulate the mouse movement, the trigger and control system needs to calibrate the projection area 103 shot by the camera head. In the scene that the projector is replaced by a display, the trigger and control system needs to calibrate the display area shot by the camera head, on the display. FIG. 2 is a schematic diagram of image calibration of a projection area shot by a camera head according to the present invention. By reference to FIG. 2, a specific calibration method in an embodiment of the present invention can be as follows.

The trigger and control system 106 controls the projector 102 to project the calibration image. The projection area 103 in FIG. 2 is the original calibration image projected by the projector. In a preferable embodiment, the calibration image can be a default image with a single color background, and contain at least four calibration reference points. The more the calibration reference points are, the more precise the identification of the coordinate transformation will be. The present embodiment employs four calibration reference points, that is, calibration reference points 11, 12, 13 and 14 in the four corners of the image, respectively. Another calibration reference point 15 may further be arranged in the center of the image. The color(s) of these calibration reference points need(s) to be sharply distinctive from the background color, so as to facilitate the camera head's acquiring the image and the trigger and control system's calibration analysis.

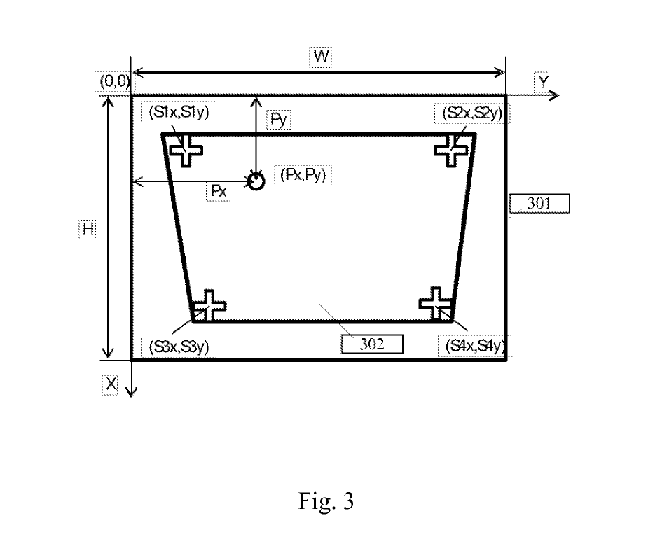

FIG. 3 is a schematic diagram of a calibration image acquired by a camera head. As shown in FIG. 3, w and h denote the width and the height of the image 301 shot by the camera head, respectively. According to the present invention, the image 301 shot by the camera head serves as a coordinate system, with the abscissa Y and the ordinate X as shown in FIG. 3, wherein the direction of the ordinate X is downward customarily in the field of computer. The origin of coordinates (0, 0) is the intersection point of X and Y, that is, the upper-left corner of the shot image 301. An area 302 in the shot image 301 is the projection area output from the projector 102, or the display area on a display in another embodiment. The projection area output from the projector 102 shall be a rectangle in a standard environment. However, since the camera head and the projector in real life may not be completely coaxial and in one to one correspondence with each other, the projection area 302 (or the display area on the display in another embodiment) shot by the camera head is often displayed as an approximate trapezoid. The four corners with the respective coordinates of (s1x, s1y), (s2x, s2y), (s3x, s3y) and (s4x, s4y) as shown in FIG. 3 are the coordinates of the four corners of the projection area 302 in the video image shot by the camera head.

Since the projector firstly projects the calibration image, the coordinate values (s1x, s1y), (s2x, s2y), (s3x, s3y) and (s4x, s4y) are the respective coordinate values of the four calibration reference points 11, 12, 13 and 14 of the calibration image 302 shot by the camera in the coordinate system with the shot image 301 as the benchmark. The method of determining the coordinate values of the calibration reference points is that: the trigger and control system 106 analyzes the shot calibration image, the color of the calibration reference points of the calibration image is sharply distinctive from the background color of the calibration image; for example, the background color of the calibration image is white, while the color of the calibration reference points is red. And the trigger and control system can also further conduct a weakening processing of the image background of the shot image so as to eliminate the image information irrelevant to the calibration reference points to highlight the calibration reference points. Then, according to the prior image coordinate analysis technique, the calibration reference points can be captured very conveniently, and the coordinate values (s1x, s1y), (s2x, s2y), (s3x, s3y) and (s4x, s4y) of the calibration reference points 11, 12, 13 and 14, respectively in the coordinate system of the video image 301 are calculated.

Secondly, the length ratio and the width ratio of the original image to the shot image need to be determined. Given that the resolution of the original computer image displayed by the projector is Ws=1024 width, Hs=768 height (pixel, the following units will all be pixel), and that the resolution of the camera head is W=1280 width, H=1024 height, then the length ratio will be Ws/W=1024/1280, and the width ratio will be Hs/H=768/1024.

Lastly, the calibration data of the projection area, that is, the coordinates (s1x, s1y), (s2x, s2y), (s3x, s3y) and (s4x, s4y) of the calibration reference points in the shot image, as well as the length ratio and the width ratio of the original image to the shot image, need to be stored.

In addition, the present invention can also employ other mature transformation algorithms to determine the coordinate mapping transformation relationship between the display area shot by the camera device and the original image output from the image output device. In an alternative embodiment, by mapping directly the coordinates of the laser point captured by the camera head 101 to the controlling point (such as, the coordinate position of the mouse) to which the resolution of the screen device corresponds, the position of the laser beam point can be determined without calibration, and then the mouse movement can be simulated. The method without requiring calibration can be used in combination with the infrared laser, so as to protect a user from being troubled by the inconsistence between the laser point and the mouse position. The arrangement of the calibration reference points in the calibration image shown in FIG. 2 and FIG. 3 is only one typical embodiment of calibration among the others, and the present invention may use other calibration methods for the calibration reference points, such as a method of arranging calibration reference points in three corners and the central point, etc.

Step s03 comprises detecting the position of the laser point in the display area shot by the camera head.

As is well known, laser is a light source with ultra brightness and excellent horizontal light-gathering capability, and is very suitable to be used as a pointing device. The key technical feature of the present invention lies in using a light point formed by an ultra bright laser beam as the controlling point of detecting long-range operations. In the present embodiment, the position of a laser point represents the position of the mouse cursor.

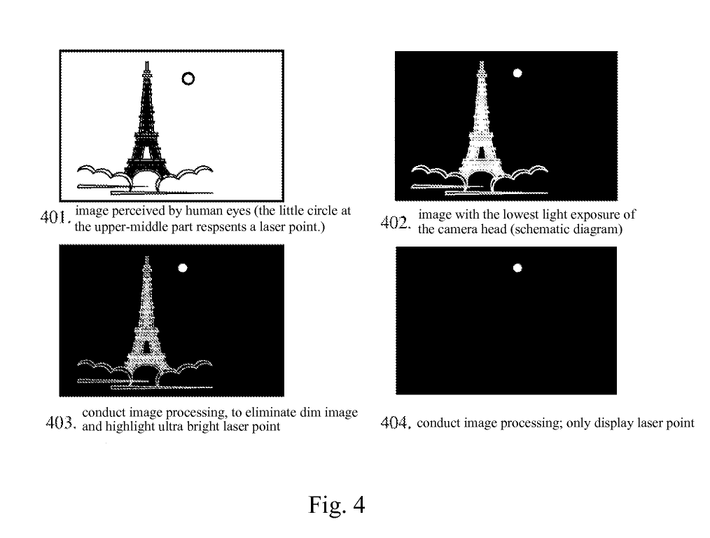

FIG. 4 is a schematic diagram of the process of detecting a laser point in an image shot by a camera head. By reference to FIG. 4, the sub-FIG. 401 represents an image perceived by human eyes, which includes an image projected by the projector (or an image displayed by the display), and a laser point formed by the user using a laser to emit a beam, wherein the round spot in the upper part of the figure represents the laser point. The trigger and control system needs to conduct a weakening processing of the image background of the shot image and eliminate the image information irrelevant to the laser point to highlight the laser point. Firstly, the trigger and control system eliminates the image information irrelevant to the laser point to highlight the information of the laser point by controlling the light exposure of the camera head. For example, one typical method is to reduce the light exposure of the camera head to the lowest level. In this case, since the brightness of the projected image is far lower than that of the laser point, the projected image in the image shot by the camera head becomes dim, while the laser point still remains distinct due to its ultra brightness, as shown in the sub-FIG. 402.

Next, the trigger and control system can also conduct a further image processing of the image of the sub-FIG. 402. One typical method is to further weaken the image information by adjusting the levels of the image, that is, to remove the remaining dim image signal, and thus to further highlight the ultra bright laser point, with the effect shown in the sub-FIG. 403. The image processing knowledge herein belongs to the well-known common technique. Of course, the present invention can also use other image processing methods to achieve eliminating the image information irrelevant to the laser point to highlight the laser point information.

At last, the control program processes the image shot by the camera head to obtain the resulting image similar to that shown by the sub-FIG. 4. This resulting image is an image having the laser point information 400 alone. On the basis of this resulting image, the laser point can be captured very conveniently according to the prior image coordinate analysis technique.

In Step s04, since the laser point has been captured, the coordinates of the detected laser point in the shot image 301 can be calculated, and in order to be more precise, the coordinate values of the mean centre of the laser point in the shot image 301 are to be calculated. Then, according to the coordinate mapping transformation relationship between the display area shot by the camera head and the original image output from the projector, the coordinates of the detected laser point are transformed into the coordinates in the original image output from the projector.

As shown in FIG. 3, suppose that (px, py) are the coordinates of the laser point in the image 301 shot by the camera head, which are obtained by the process shown in FIG. 4. Then, according to the abovementioned stored coordinates (s1x, s1y), (s2x, s2y), (s3x, s3y) and (s4x, s4y) of the calibration reference points of the projection area in the shot image, and the stored length ratio and width ratio of the original image to the shot image, the coordinates (PX, PY) of the laser point in the original image output from the projector can be calculated by the transformation. The specific calculating methods are conventional techniques in the art, among which one method, for example, is as follows:

First of all, the coordinates (S0x, S0y) of the central point of the four calibration reference points in the shot image are determined as:

S0x=(s1x+s2x+s3x+s4x)/4

S0y=(s1y+s2y+s3y+s4y)/4

Secondly, the coordinates (PX, PY) of the laser point in the original image output from the projector are determined as:

PX=[(Px−S0x)*Ws/(s2x−s1x+s4x+s3x)+Ws/2]*Ws/W

PY=[(Py−S0y)*Hs/(s3y−s1y+s4y +s2y)+Hs/2]*Hs/H

In an embodiment of simulating a mouse movement, the coordinate position of the abovementioned laser point in the original image is exactly the position of the mouse cursor in the original image. The trigger and control system can control the display of the mouse cursor in this position.

Just like a typical video image provided by a camera head, which comprises 30 frames of image per second, the trigger and control system will process each frame of the video captured by the camera head, so as to obtain the position of the laser beam point in the image by the abovementioned Step s03 and Step s04. According to the coordinate mapping transformation relationship between this position and the previous original image, the position of the laser beam point can be transformed into the position in which the mouse cursor should be. The control program processes in real time the image shot by the camera head, and moves in real time the mouse cursor to the position of the laser point, so as to simulate the effect of the laser mouse cursor.

Step s05 comprises identifying the coding signal delivered from the laser point, wherein when the coding signal is identified as corresponding to a human-computer interaction operation command, the human-computer interaction operation command corresponding to the coding signal is triggered at the coordinates in the original image correspondingly transformed from the coordinates of the laser point.

In the present embodiment, the laser beam point is configured to flicker according to a specific coding mode, so as to correspond to an operation command for mouse click, including single click, right-button, double clicks, press and drag, etc. However, the present invention is not limited to the flickering code of laser point, and more complicated coding modes can be composed and interpreted according to the principle of the present invention.

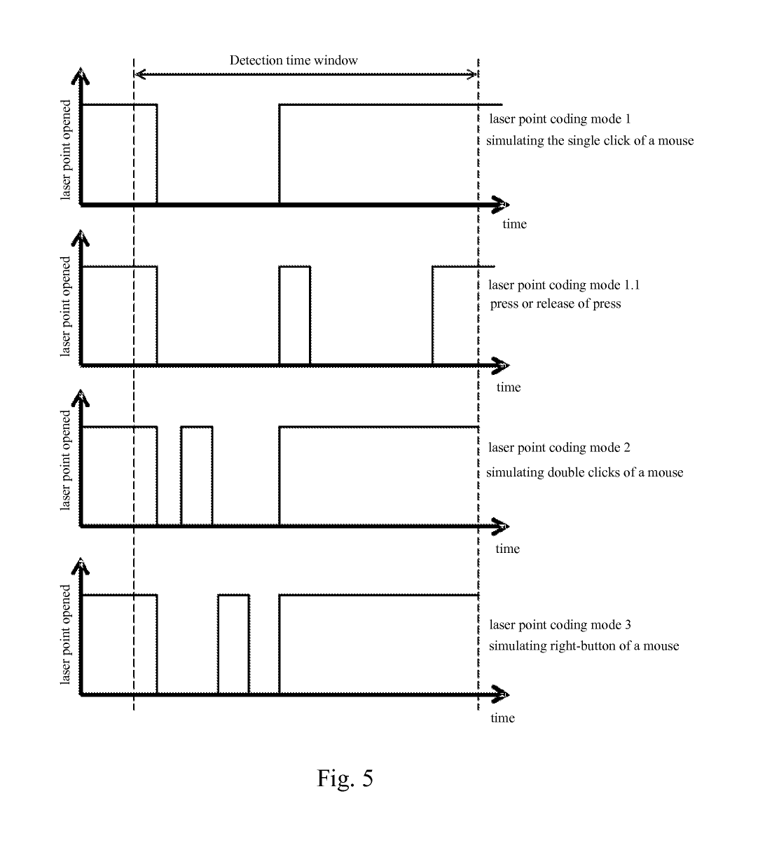

FIG. 5 is a schematic diagram of a flicking code of laser beam. By reference to FIG. 5, the ordinate denotes the opening/closing state of the laser beam, wherein the top edge of the square wave represents the laser is opened, and the bottom edge of the square wave represents the laser is closed. Different modes of flickering code of the laser beam correspond to different mouse operations.

In this step, a specific method for identifying the coding signal from the laser point is as follows.

The control program, according to the methods in Step s03 and Step s04, acquires the image sequence of the laser point, continuously detects the laser point in each frame of image that has been shot, determines the flickering code of the laser point in the successive frames in a predetermined detection time window, and matches it to predetermined (such as the flickering mode shown in FIG. 5) human-computer interaction operation commands represented by the flickering modes of laser point. If it matches one of human-computer interaction operation commands, then it is determined that the coding signal corresponding to this human-computer interaction operation command has been identified, which will serve as the basis for the trigger and control system's simulating a mouse operation such as single click, double clicks, long press or release of long press. The corresponding mouse operation command will be triggered at the coordinates of the laser point in the original image.

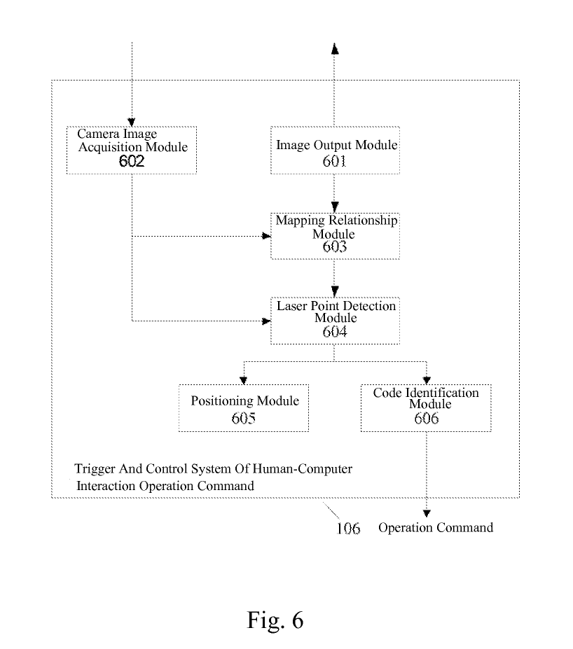

FIG. 6 is a schematic diagram of the trigger and control system 106 of human-computer interaction operation command according to the present invention. By reference to FIG. 6, the trigger and control system 106 is mainly used to implement the abovementioned processing methods according to the present invention, and particularly comprises:

an image output module 601, which is connected to the projector interface 104, for providing the original mage to be output from the image output device;

a camera image acquisition module 602, which is connected to the camera interface 107, for acquiring the display area that is output from the image output device and shot by the camera device;

a mapping relationship module 603, which is configured to determine the coordinate mapping transformation relationship between the display area shot by the camera device and the original image output from the image output device;

a laser point detection module 604, which is configured to detect a laser point in the display area shot by the camera device;

a positioning module 605, which is configured to determine the coordinates of the detected laser point, and transform the coordinates of the detected laser point into the coordinates in the original image output from the image output device according to the coordinate mapping transformation relationship between the display area shot by the camera device and the original image output from the image output device;

a code identification module 606, which is configured to identify the coding signal delivered from the laser point, wherein when the coding signal delivered from the laser point is identified as corresponding to a human-computer operation command, the human-computer interaction operation command corresponding to the coding signal is triggered at the coordinates in the original image correspondingly transformed from the coordinates of the laser point.

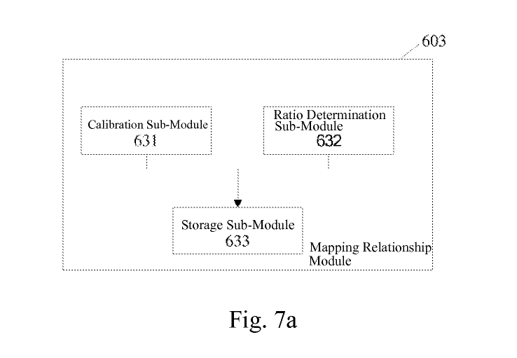

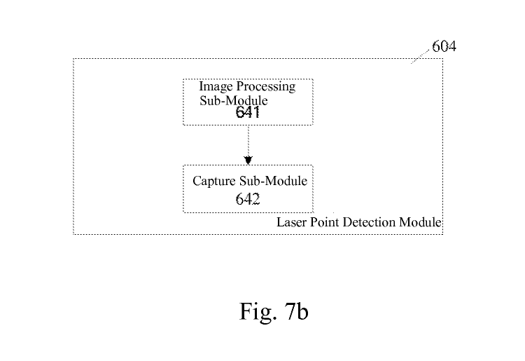

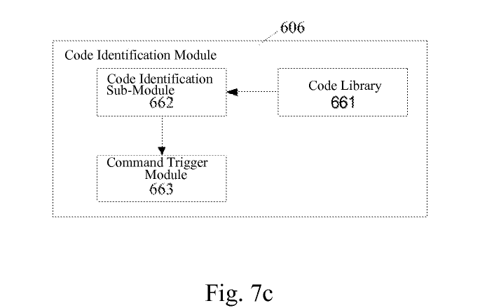

Further, as shown in FIG. 7a, the mapping relationship module 603 may particularly comprise:

a calibration sub-module 631, which is configured to control the image output module to provide the original calibration image containing at least three calibration reference points, and to determine the coordinates of the calibration reference points in the shot image shot by the camera device;

a ratio determination sub-module 632, which is configured to determine the length ratio and the width ratio of the image shot by the camera device to the original image output from the image output device; and

a storage sub-module 633, which is configured to store the coordinates of the calibration reference points in the shot image, as well as the length ratio and the width ratio of the original image to the shot image.

Further, as shown in FIG. 7b, the laser point detection module may particularly comprise:

an image processing sub-module 641, which is configured to conduct a weakening processing of the image background of the shot image, so as to eliminate the image information irrelevant to the laser point to highlight the laser point; and

a capture sub-module 642, which is configured to capture the highlighted laser point from the shot image that has been processed by the image processing sub-module 641.

Further, as shown in FIG. 7c, the code identification module 606 particularly comprises:

a code library 661, which is configured to store the laser coding modes corresponding to human-computer interaction operation commands;

a code identification sub-module 662, which is used to acquire the laser point in each frame continuously detected by the laser point detection module 604, determine the flickering code of the laser point in the successive frames in a predetermined detection time window, and compare it with the laser coding modes stored in the code library; if it matches a laser coding mode corresponding to a certain human-machine interaction operation command, it is determined that the coding signal corresponding to the human-computer interaction operation command has been identified;

a command trigger mode 663, which is configured to trigger the human-computer interaction operation command corresponding to the coding signal identified by the code identification module 662, at the coordinates of the laser point in the original image, which are determined by the positioning module 605.

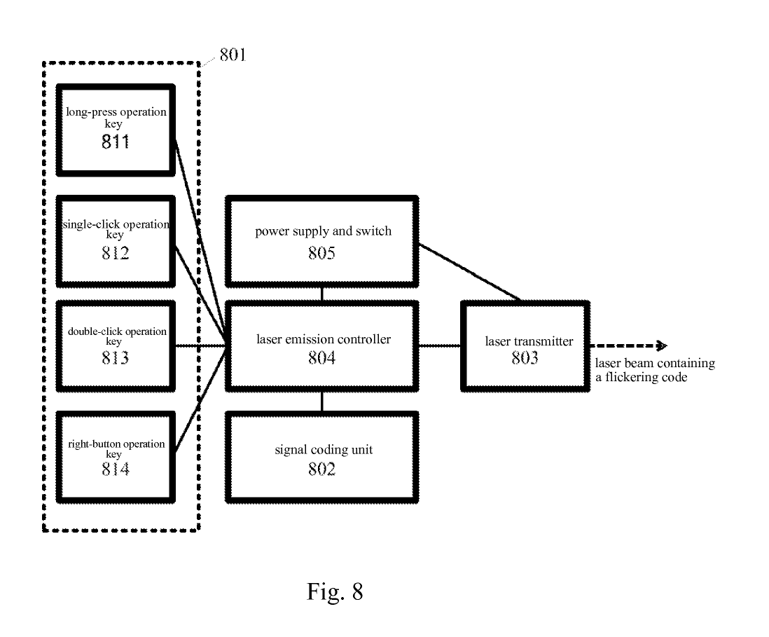

It can be understood that the abovementioned functional modules can be built in a smart terminal to form an integrated equipment. The abovementioned smart terminal may be, such as, a mobile phone, a tablet computer, a television, a projector, and other hand-held terminals. In addition, the light point detected by the laser point detection module 604 is emitted by a laser emission device, which can be a separate device, and also can be integrated into the abovementioned smart terminal. That is, the abovementioned trigger and control system 106 of human-computer interaction operation command can also comprise a laser emission device. As regards further details about the laser emission device, reference can be made to the following FIG. 8 and the relevant description thereof.

If a user is aware of the flickering coding signal, a common laser transmitter may be accordingly used for transmitting the flickering coding signal by the user himself/herself, so as to conduct a long-range human-computer interaction. However, by using this method, a person usually cannot precisely make the corresponding flickering coding signal when operating a laser transmitter by pressing, thereby affecting the precision of human-computer interaction. Therefore, the present invention also discloses a laser emission device associated with the abovementioned trigger and control system of human-computer interaction operation command.

FIG. 8 is a schematic diagram of this laser emission device. By reference to FIG. 8, this laser emission device comprises:

a trigger key of human-computer interaction operation command 801, which is configured to trigger a corresponding human-computer interaction operation command;

a signal coding unit 802, which is configured to store the laser coding modes corresponding to human-computer interaction operation commands;

a laser transmitter 803, which is configured to emit a laser beam;

a laser emission controller 804, which is configured to, according to a human-computer interaction operation command triggered by the trigger key of human-computer interaction operation command, read the corresponding laser coding mode thereto from the signal coding unit, and to control the laser transmitter to transmit a laser beam representing a corresponding laser-coding signal. Of course, it also comprises a power supply and switch 805.

The trigger key of human-computer interaction operation command 801 may include at least one of the following trigger keys:

a mouse operation key, which is configured to trigger a mouse operation command;

a single touch operation key, which is configured to trigger a single touch operation command;

a multi-touch operation key, which is configured to trigger a multi-touch operation key.

In the present embodiment, a wireless mouse (Bluetooth or 2.4 G, etc.) working module can be integrated into the laser transmitter 803, whereby the left-button, right-button and double-clicks operations of the wireless mouse can be used directly for this purpose.

In the present embodiment, the trigger key of human-computer interaction operation command is a mouse operation key, which, for example, particularly includes: a long-press operation key 811 used to trigger a long-press operation command, a single-click operation key 812 used to trigger a single-click operation command, a double-click operation key 813 used to trigger a double-click operation command, and a right-button operation key 814 used to trigger a right-button operation command.

In the present embodiment, the laser-coding signal transmitted by the laser transmitter is a laser flickering signal. The laser coding mode in the signal coding unit 802 can be the coding mode shown in FIG. 5, which is completely consistent with the coding mode stored in the code library 661 of the trigger and control system 106. When a user presses one of the mouse operation keys, the laser emission controller 804 controls the laser transmitter 803 to transmit the laser flickering signal (that is, the laser beam containing a flickering code), which corresponds to the operation command represented by this press button as shown in FIG. 5. The trigger and control system 106 then can identify this laser flickering signal, match it to laser coding modes from the code library 661 so as to determine the corresponding laser coding mode, and thus which one is the corresponding operation command, so as to finally trigger this operation command. However, the present invention is not limited to the flickering coding signal of laser point. More complicated coding modes can be composed and interpreted according to the principle of the present invention.

In addition, the laser emission device can be a device integrated into a smart terminal, and the abovementioned smart terminal may be, for example, a mobile phone, a tablet computer, a television, a projector, and other hand-held terminals.

In the embodiments of the present invention disclosed as above, a camera is used to monitor the image of the data processing equipment projected by the projector. The trigger and control system on the data processing equipment can analyze the content shot by the camera, conduct the image analysis, and distinguish the position that the laser points at the projected image. The trigger and control system will manage the mouse cursor position on the data processing equipment, and resolve the flashing command codes emitted from the laser, so as to simulate mouse operations, including single click, double clicks, right-button, long-press drag, or the like. Thus, it is convenient for a user to use a laser emission device for medium range and long range controlling of a computer interface in case where the user is not near the computer, wherein not only the operations are convenient, but also the operation commands can be diversified. That is, if the user wants to add a control operation command, he/she only needs to add the corresponding laser coding mode thereto into the code library 661 and the signal coding unit 802.

The present invention can also simulate the single touch operation of touch screen operations, and use more than one laser emission devices to simulate the multi-touch operations of a touch screen, etc. When simulating a multi-touch operation, more than one laser transmitters are needed to shoot more than one laser points on the projection screen. The more than one laser transmitters can be integrated into one laser emission device, and the coding mode, in which a plurality of laser points cooperate with each other, corresponding to the multi-touch operation command can be stored in the signal coding unit 802. For example, that two laser points are designed to flicker two times at the same time at the same frequency represents a zoom-in gesture operation command in multi-touch operations, and that two laser points are designed to flicker three times at the same time at the same frequency represents a zoom-out gesture operation command in multi-touch operations, etc. When a user presses a multi-touch operation key (for example, it may include keys for zoom-in gesture operation command and zoom-out gesture operation command), the laser emission controller 804 reads the corresponding multi-point laser coding mode thereto from the signal coding unit, and controls the more than one laser transmitters to emit laser beams representing the corresponding laser-coding signal; for example, the zoom-in gesture operation command corresponds to the case where two laser transmitters emit at the same time two laser beams, each of which flickers two times at the same frequency. The code library 661 of the trigger and control system 106 also needs to further store multi-touch operation commands, each of which is represented by a cooperation of a plurality of laser point coding modes. For example, that two laser points flicker two times at the same time at the same frequency represents a zoom-in gesture operation command, while that two laser points flicker three times at the same time at the same frequency represents a zoom-out gesture operation command. When two laser points are detected and identified to flicker two times at the same time at the same frequency, it is determined that the zoom-out gesture touch operation command has been triggered, and then, the zoom-out operation will be triggered and executed.

The abovementioned contents are only presented as the embodiments of the present invention, and do not constitute any form of restriction on the present invention. While the present invention has been disclosed as above by the embodiments, they are not meant to limit the present invention. Any person skilled in the art could somewhat alter or modify the illustrated technical contents into equivalent embodiments without departing from the scope of the technical solutions of the present invention. Any simple revision, equivalent change and modification made to the above embodiments according to the technical essence of the present invention, without departing from the contents of the technical solutions of the present invention, still falls within the scope of the technical solutions of the present invention.

What is claimed is:

1. A trigger and control method of human-computer interaction operation command, comprising:
shooting a display area output from an image output device by using a camera device;
determining a coordinate mapping transformation relationship between the display area shot by the camera device and an original image output from the image output device;
detecting a laser point in the display area shot by the camera device, determining the coordinates of the detected laser point, and transforming the coordinates of the detected laser point into the coordinates in the original image output from the image output device according to the coordinate mapping transformation relationship between the display area shot by the camera device and the original image output from the image output device; and
identifying a coding signal delivered from the laser point, wherein when the coding signal delivered from the laser point is identified as corresponding to a human-computer interaction operation command, the human-computer interaction operation command corresponding to the coding signal is triggered at the coordinates in the original image correspondingly transformed from the coordinates of the laser point.

2. The method according to claim 1, wherein the determining the coordinate mapping transformation relationship between the display area shot by the camera device and the original image output from the image output device comprises:
controlling the image output device to output the original calibration image containing at least four calibration reference points, and determining the coordinates of the calibration reference points in the shot image shot by the camera device; and determining the length ratio and the width ratio of the shot image to the original image output from the image output device;
the determining the coordinates of the detected laser point comprises: determining the coordinates of the detected laser point in the shot image.

3. The method according to claim 2, wherein the color of the calibration reference points in the calibration image is distinctive from the background color of the calibration image; and
the determining the coordinates of the calibration reference points in the shot image shot by the camera device comprises: conducting a weakening processing of the image background of the shot image, so as to eliminate the image information irrelevant to the calibration reference points to highlight the calibration reference points; and capturing the calibration reference points and calculating the coordinates of the calibration reference points in the shot image.

4. The method according to claim 1, wherein the detecting a laser point is carried out by the following steps:
conducting a weakening processing of the image background of the shot image, so as to eliminate the image information irrelevant to the laser point to highlight the laser point, and capturing the highlighted laser point.

5. The method according claim 4, wherein the conducting the weakening processing of the image background of the shot image comprises: reducing the light exposure of the camera device, and adjusting the levels of the shot image.

6. The method according to claim 1, wherein the identifying the coding signal delivered from the laser point is carried out by the following steps:
continuously detecting the laser point in each frame of the shot image, determining the flickering code of the laser point in the successive frames in a predetermined detection time window, and matching the flickering code to predetermined human-computer interaction operation commands represented by the flickering modes of the laser point, wherein if the flickering code matches a human-computer interaction operation command, then it is determined that the coding signal corresponding to this human-computer interaction operation command has been identified.

7. The method according to claim 1, wherein the human-computer interaction operation command corresponding to the coding signal of the laser point comprises: mouse operation command, single-touch operation command, and multi-touch operation command.

8. A trigger and control system of human-computer interaction operation command, comprising:
an image output module, which is configured to provide an original image to be output from an image output device;
a camera image acquisition module, which is configured to acquire a display area that is output from the image output device and shot by a camera device;
a mapping relationship module, which is configured to determine a coordinate mapping transformation relationship between the display area shot by the camera device and the original image output from the image output device;
a laser point detection module, which is configured to detect a laser point in the display area shot by the camera device;
a positioning module, which is configured to determine the coordinates of the detected laser point, and transform the coordinates of the detected laser point into the coordinates in the original image output from the image output device according to the coordinate mapping transformation relationship between the display area shot by the camera device and the original image output from the image output device; and
a code identification module, which is configured to identify a coding signal delivered from the laser point, wherein when the coding signal delivered from the laser point is identified as corresponding to a human-computer operation command, the human-computer interaction operation command corresponding to the coding signal is triggered at the coordinates in the original image correspondingly transformed from the coordinates of the laser point.

9. The system according to claim 8, wherein the mapping relationship module comprises:
a calibration sub-module, which is configured to control the image output module to provide the original calibration image containing at least three calibration reference points, and to determine the coordinates of the calibration reference points in the shot image shot by the camera device;
a ratio determination sub-module, which is configured to determine the length ratio and the width ratio of the image shot by the camera device to the original image output from the image output device; and
a storage sub-module, which is configured to store the coordinates of the calibration reference points in the shot image, as well as the length ratio and the width ratio of the original image to the shot image.

10. The system according to claim 8, wherein the laser point detection module comprises:
a image processing sub-module, which is configured to conduct a weakening processing of the image background of the shot image, so as to eliminate the image information irrelevant to the laser point to highlight the laser point; and
a capture sub-module, which is configured to capture the highlighted laser point from the shot image that has been processed by the image processing sub-module.

11. The system according to claim 8, wherein, the code identification module comprises:
a code library, which is configured to store laser coding modes corresponding to human-computer interaction operation commands;
a code identification sub-module, which is used to acquire the laser point in each frame continuously detected by the laser point detection module, determine the flickering code of the laser point in the successive frames in a predetermined detection time window, and compare the flickering code with the laser coding modes stored in the code library; if the flickering code matches a laser coding mode corresponding to a human-machine interaction operation command, it is determined that the coding signal corresponding to the human-computer interaction operation command has been identified; and
a command trigger mode, which is configured to trigger the human-computer interaction operation command corresponding to the coding signal identified by the code identification module, at the coordinates of the laser point in the original image, which are determined by the positioning module.

12. The system according to claim 8, further comprising: a laser emission device, which is used to emit a laser so as to form the laser point.

13. The system according to claim 8, wherein the trigger and control system of human-computer interaction operation command is built into a smart terminal.

14. A laser emission device associated with a trigger and control system of human-computer interaction operation command, the device comprising:
a trigger key of human-computer interaction operation command, which is configured to trigger a corresponding human-computer interaction operation command thereto;
a signal coding unit, which is configured to store laser coding modes corresponding to human-computer interaction operation commands;
a laser transmitter, which is configured to transmit a laser beam; and
a laser emission controller, which is configured to, according to the human-computer interaction operation command triggered by the trigger key of a human-computer interaction operation command, read the corresponding laser coding mode thereto from the signal coding unit, and to control the laser transmitter to transmit a laser beam correspondingly representing a laser-coding signal.

15. The laser emission device according to claim 14, wherein the laser-coding signal transmitted by the laser transmitter is a laser flickering signal.

16. The laser emission device according to claim 14, wherein the trigger key of human-computer interaction operation command comprises a mouse operation key, which comprises: a long-press operation key used to trigger a long-press operation command, a single-click operation key used to trigger a single-click operation command, a double-click operation key used to trigger a double-click operation command, and a right-button operation key used to trigger a right-button operation command.

17. The laser emission device according to claim 14, wherein the device comprises more than one the laser transmitters, and
the trigger key of human-computer interaction operation command includes a multi-touch operation key, which is used to trigger a multi-touch operation command;
the signal coding unit stores a coding mode, in which a plurality of laser points cooperate with each other, corresponding to the multi-touch operation command; and
after receiving a trigger command from the multi-touch operation key, the laser emission controller reads the multi-point laser coding mode corresponding to the trigger command from the signal coding unit, and controls the more than one laser transmitters to transmit the laser beam representing the corresponding laser-coding signal.

18. The laser emission device according to claim 14, wherein the laser emission device is integrated into a smart terminal.
